(19) United States
(12) Patent Application Publication
(10) Pub. No.: US 2025/0241453 A1
(43) Pub. Date: Jul. 31, 2025

(54) COIL SPRING FOR RESILIENT UNIT

(71) Applicant: HS PRODUCTS LTD, Leeds (GB)

(72) Inventor: Simon Spinks, West Yorkshire (GB)

(21) Appl. No.: 18/855,811

(22) PCT Filed: Apr. 11, 2023
(86) PCT No.: PCT/GB2023/050955

§ 371 Date: Oct. 10, 2024

(30) Foreign Application Priority Data
Apr. 11, 2022 (GB) 2205275.7

(51) Int. Cl. A47C 27/06

(52) U.S. Cl. CPC A47C 27/062; A47C 27/064; A47C 27/065

(57) ABSTRACT

A single, continuous coiled spring, generally at 400, is formed into two distinct spring portions 400A and 400B, of generally constant pitch, separated by a transition portion 450 approximately half-way along the spring 400. The transition portion 450 comprises at least one turn which is of a reduced pitch in the example, but which may be of a zero pitch or even a negative pitch. The spring is encased in a continuous pocket P. In this case, the transition portion 450 includes a substantially flat turn. The spring portions 400A and 400B comprise a common portion of spring material in this case spring wire and the coils are substantially continuous throughout the overall spring 400.

The present invention relates to a coil spring for use in a resilient unit, and is concerned particularly, although not exclusively, with a coil spring for use in a pocketed resilient unit, such as may form a core of an upholstered article.

Resilient units, for example as are used in the core of a mattress, typically comprise an array of helical compression springs. The springs are helically coiled and may have various shapes, including simple cylindrical springs, in which the coils are all of substantially the same diameter, or else barrel-shaped springs, with at least one coil towards the axial mid-part being of greater diameter than those at the axial ends, conical springs, in which the diameters of the coils increases from one axial end to the other, and even hourglass shapes in which one or more coils towards the axial mid-part of the spring are of a reduced diameter when compared with those at the axial ends. One thing that they have in common is that at the axial ends of the spring, the pitch of the coils—i.e. the distance between the centres of adjacent coils or turns—has to be reduced. In other words, the one or more coils/turns of the spring that are located at the very axial ends are flat or even turned back towards the spring body. This is so that the wire at the ends of the spring does not project beyond the end and thereby cause discomfort to someone using the resilient unit. With pocketed spring units, in which the springs are encased in individual bags or pockets of material, this turning also has the benefit of avoiding unnecessary wear and tear on the pocketing material.

As well as the shape and resilience of the springs, the sheer number of them will have an effect on the comfort level of the resilient unit. Therefore, manufacturers try to find ways of maximising the number of springs in a mattress. One way of doing this is to stack springs, one upon the other, axially. An example of a resilient unit in which pocketed springs are stacked axially is to be found in our published PCT patent application number WO 2000000065, the entire contents of which are hereby incorporated by reference.

The end-most turns of the spring, having reduced or zero or even negative pitch (turns back into the body of the spring), contribute little or nothing to the resilience of the spring. Therefore, when springs are stacked, there is considerable waste of spring material—typically steel wire—at the places where the springs abut.

Embodiments of the present invention aim to provide a spring design in which the aforementioned problems are at least partly addressed.

The present invention is defined in the attached independent claims, to which reference should now be made. Further, preferred features may be found in the sub-claims appended thereto.

According to one aspect of the present invention, there is provided a coil spring for use in a resilient unit, the spring comprising a plurality of coils about a spring axis, extending from a first axial end to a second axial end, and having at least first and second substantially co-axial spring portions and a transition portion therebetween, wherein the pitch of the transition portion is less than the pitch of the first and second spring portions.

The spring is preferably substantially helically coiled.

The first and second spring portions may comprise a common length of spring material, more preferably of wire. The first and second spring portions and the transition portion may comprise a substantially continuous wire.

The first spring portion may comprise a first number of coils and the second spring portion may comprise a second number of coils (turns) and the transition portion may comprise a third number of coils. In a preferred arrangement the average pitch of the coil(s) of the transition portion is less than the average pitch of the coils of the first and/or the second spring portions.

The first and second spring portions may comprise substantially the same shape, which shape may be any of (but not limited to): cylindrical, barrel-shaped, conical or hourglass, for example. Alternatively, the first and second spring portions may be of different shape.

The spring may have a substantially constant shape along its length. In a preferred arrangement, the diameters of the first and second spring portions, and more preferably also of the transition portion, are substantially the same. The diameter of the coils may be substantially the same along the entire length of the spring. The transition portion may comprise at least one substantially flat coil portion. The or each substantially flat coil portion may comprise a substantially flat portion of a coil or a substantially flat coil.

The coils are preferably spaced from one another. This may allow substantially all of the coils to act independently and preferably to contribute to the compression characteristic of the spring.

The ends of the spring may comprise at least one substantially flat coil.

The spring may be encased within a pocket.

The invention includes a resilient unit comprising an array of springs according to any statement herein, which is preferably suitable for use as, or part of, an upholstered article, such as a mattress, seat, pad or panel.

The invention also includes an upholstered article, such as a mattress, seat, pad or panel, incorporating one or more springs according to any statement herein, or incorporating a resilient unit according to any statement herein.

According to a second aspect of the invention, there is provided a method of making a coil spring, the method comprising producing coils of a first pitch, then reducing the pitch followed by increasing the pitch.

The method preferably comprises producing a first spring portion then a transition portion then a second spring portion. The first and second spring portions and the transition portion may comprise common wire and preferably are of substantially continuous coils.

The method may comprise providing a substantially reduced pitch region at a transition portion of the spring, between the first and second spring portions. Preferably the method comprises producing a substantially flat coil or turn at a transition portion part way along an axial length of the spring, which transition portion is not at an axial end of the spring.

The invention may include any combination of the features or limitations referred to herein, except such a combination of features as are mutually exclusive, or mutually inconsistent.

A preferred embodiment of the present invention will now be described, by way of example only, with reference to the accompanying diagrammatic drawings, in which:

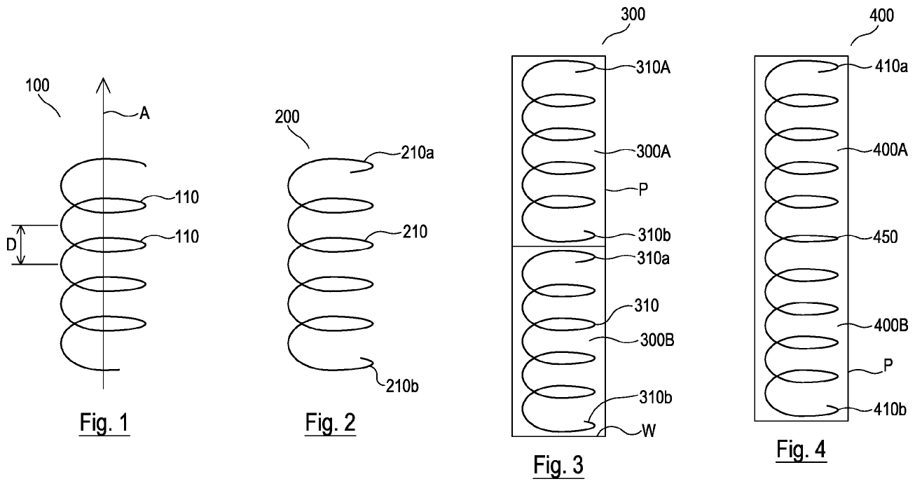

FIG. 1 shows a simple, helically coiled spring according to the prior art;

FIG. 2 shows a helically coiled spring with end coils turned in;

FIG. 3 shows a two-up stacked, pocketed spring; and

FIG. 4 shows a spring according to an embodiment of the present invention.

Turning to FIG. 1, this shows a previously considered helically coiled spring, generally at 100. The spring 100 comprises a number of turns, or coils, 110 about a spring axis A. The turns or coils are of constant pitch—i.e. the distance D between the turns or coils is substantially constant.

The manufacture of helically coiled wire springs currently involves a number of steps. Firstly, the wire is taken using feed rollers from a supply, which is typically a reel and, if necessary, the wire is straightened to remove any kinks or twists. The wire is then formed into helical coils using a first deflecting tool to instigate a bend in a first direction and then a second deflecting tool, arranged substantially perpendicular to the first, to instigate a bend in a second direction. This urges the wire out of plane, and into a helix. A pitching tool controls the separation of adjacent turns or coils, according to requirements, and when the coil is of a predetermined length a cutter severs the spring from the rest of the wire, or else separation of the spring is effected another way, for example by causing the wire to separate at a previously formed irregularity.

FIG. 2 shows a previously considered helically coiled spring, generally at 200, comprising turns or coils 210. This spring has been adapted for use in an upholstered article (not shown) in that at each axial end there are coils 210a and 210b that are turned in—i.e. the pitch of the end-most turns is zero or negative. This is done in the interests of comfort for the user of an upholstered article containing the spring, as it ensures that there are no pointed ends to the spring. It is also useful in avoiding excessive or premature wearing of any pocketing material when the spring is encased in a pocket (not shown).

FIG. 3 shows, schematically, a previously considered pocketed spring, generally at 300. In this case, there are two springs 300A and 300B stacked one upon the other. Each spring is in a pocket P. the pockets may be formed in a number of ways, such as by welding ultrasonically two webs of pocketing material along edges and between the springs to form welds W. The pocketing material may comprise spun-bonded polyester, for example. Note that each of the two springs 300A and 300B has a number of coils 310 and has a turned-in coil 310a and 310b at each end, making a total of four turned-in coils. Since the turned in coils are of a zero pitch, or a negative pitch, their contribution to the resilient characteristic of the spring is negligible and they are essentially wasted material.

FIG. 4 shows an embodiment of the present invention, in which a single, continuous coiled spring, generally at 400, is formed into two distinct spring portions 400A and 400B, of generally constant pitch, separated by a transition portion 450 approximately half-way along the spring 400. The transition portion 450 comprises at least one turn which is of a reduced pitch in the example, but which may be of a zero pitch or even a negative pitch. The spring is encased in a continuous pocket P. In this case, the transition portion 450 includes a substantially flat turn. The spring portions 400A and 400B comprise a common portion of spring material-in this case spring wire-and the coils are substantially continuous throughout the overall spring 400.

The two spring portions 400A and 400B provide the comfort and resilience of the two separate springs of the prior art example described with reference to FIG. 3. However, whilst there are two distinct spring portions, 400A and 400B, they share a common transition portion 450 and so do not require the separate turned-in ends that are to be found in the FIG. 3 arrangement, there being only two such coils 410a and 410b at opposite axial ends of the spring 400.

This saves material. Specifically, for every pair of spring portions 400A and 400B, only two turned-in ends and one common transition portion are needed, rather than the four turned-in ends of the prior art arrangement, which is a 25% saving of wasted steel.

Furthermore, if more integrated spring portions are used, such as three spring portions sharing two transition portions, savings are also made (33%) and so on for other combinations. The example shown is of a spring having just two spring portions with a transition portion therebetween.

The spring could comprise three or more spring portions, with a transition portion between each adjacent pair of spring portions.

In the example shown in FIG. 4, the first and second spring portions, along with the transition portion, are of substantially the same diameter. In addition, the coils are all spaced from one another, so that the coils may all act independently of one another and so that substantially all of the coils may contribute to the compression characteristic of the spring.

The transition portions can comprise a single, flat turn, or a single turn of lower pitch than that of the turns in the main spring portions, or else the transition portion can comprise a plurality of turns, of which one, all or some are of a reduced, zero or negative pitch, or a reduce average pitch.

The spring portions need not be of the same length. The transition portion, or one of the transition portions if there are more than one, could lie closer to one end of the overall spring, for example.

The spring portions may have substantially the same shape or may have different shapes, which may include any, or any combination, of (but not limited to): flat/cylindrical, barrel shaped, conical or hourglass, for example.

The transition portion, part-way along the spring, mimics the turned-in region usually found at the axial ends of the spring in one or more of its pitch, geometry and dimensional characteristics.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

1. A coil spring for use in a resilient unit, the spring comprising a plurality of coils about a spring axis, extending from a first axial end to a second axial end, and having at least first and second substantially co-axial spring portions and a transition portion therebetween, wherein the pitch of the transition portion is less than the pitch of the first and second spring portions.

2. A spring according to claim 1, wherein the first and second spring portions comprise a common length of spring material, more preferably of wire.

3. A spring according to claim 1, wherein the first and second spring portions and the transition portion comprise a substantially continuous wire.

4. A spring according to claim 1, wherein the first spring portion comprises a first number of coils and the second spring portion comprises a second number of coils (turns) and the transition portion comprises a third number of coils.

5. A spring according to claim 1, wherein the average pitch of the coil(s) of the transition portion is less than the average pitch of the coils of the first and/or the second spring portions.

6. A spring according to claim 1, wherein the first and second spring portions comprise substantially the same shape, which shape is one of (but not limited to): cylindrical, barrel-shaped, conical or hourglass.

7. A spring portion according to claim 1, wherein the diameters of the first and second spring portions, and also of the transition portion, are substantially the same.

8. A spring portion according to claim 1, wherein the first and second spring portions are of different shape.

9. A spring according to claim 1, wherein the transition portion comprises at least one substantially flat coil portion.

10. A spring portion according to claim 9, wherein the or each substantially flat coil portion comprises a substantially flat portion of a coil or a substantially flat coil.

11. A spring according to claim 1, wherein the spring is encased within a pocket.

12. A spring according to claim 1, wherein all of the coils are spaced from one another.

13. A resilient unit comprising an array of springs according to claim 1, in, or as part of, an upholstered article, such as a mattress, seat, pad or panel.

14. An upholstered article, such as a mattress, seat, pad or panel, incorporating one or more springs according to claim 1.

15. A method of making a coil spring, the method comprising producing coils of a first pitch, then reducing the pitch followed by increasing the pitch.

16. A method according to claim 15, the method comprising producing a first spring portion then a transition portion then a second spring portion.

17. A method according to claim 15, wherein the method comprises providing a substantially reduced pitch region at a transition portion of the spring, between the first and second spring portions.

18. A method according to claim 15, comprising producing a substantially flat coil or tum at a transition portion part way along an axial length of the spring, which transition portion is not at an axial end of the spring.
